(19) United States
(12) Patent Application Publication
(10) Pub. No.: US 2020/0280440 A1
(43) Pub. Date: Sep. 3, 2020

(54) RECOVERING ACCESS TO A DIGITAL SMART CONTRACT WALLET

(71) Applicant: OST.COM INC., New York, NY (US)

(72) Inventors: Benjamin BOLLEN, Berlin (DE); Jason GOLDBERG, Berlin (DE)

(21) Appl. No.: 16/804,782

(22) Filed: Feb. 28, 2020

Related U.S. Application Data
(60) Provisional application No. 62/812,561, filed on Mar. 1, 2019.

(51) Int. Cl. H04L 9/08; G06Q 10/10; G06Q 20/36; G06Q 20/38

(52) U.S. Cl. CPC H04L 9/0894; H04L 9/0863; G06Q 10/10; G06Q 20/36; G06Q 2220/00; G06Q 20/3829; H04L 2209/38; H04L 2209/56; G06Q 20/3825

(57) ABSTRACT

Systems and methods for recovering access to a digital smart contract wallet stored on a blockchain. A new owner public-private key pair is created to replace a current owner public-private key pair for accessing the digital smart contract wallet. The digital smart contract wallet on the blockchain is updated to require a transaction signed by a new owner private key of the new owner public-private key pair for accessing the digital smart contract wallet. The digital smart contract wallet is updated using a recovery transaction signed by a recovery owner private key and a recovery controller private key to update the digital smart contract wallet on a blockchain to require signing transactions with the new owner private key. The recovery owner private key is part of a key pair with the recovery owner public key, and the recovery controller private key is part of a key pair with the recovery controller public key.

### CROSS-REFERENCE TO RELATED APPLICATIONS

This application claims priority under 35 U.S.C. § 119 to U.S. Provisional Application No. 62/812,561, filed Mar. 1, 2019, the entire disclosure of which is herein expressly incorporated by reference.

### BACKGROUND

### Technical Field

Embodiments of the disclosed subject matter generally relate to systems and methods for recovering access to a digital smart contract wallet that has been lost or stolen.

### Discussion of the Background

Cryptocurrencies stored in blockchains have become increasingly accepted within the financial community, as well as other communities, as a viable alternative to government-issued currencies, as well as new opportunities for investments. There are, however, a number of technological issues that are preventing more widespread adoption of cryptocurrencies.

Typically, a user's digital wallet stores a private key that “holds” the cryptocurrency. In the context of cryptocurrency, the private key “holds” the cryptocurrency in the sense that the software administering the particular cryptocurrency, such as a smart contract on a blockchain, maps a balance to the public address of an account on the blockchain. This public address is a public key that is part of a key pair with the private key that is stored in the user's digital wallet.

The private key is generated using data, which is converted into a seed phrase, which is a human-friendly representation of that data. Thus, the data used to generate the private key can be obtained using the seed phrase. A seed phrase consists of a particular number of random words, with twelve words being one of the most common. The seed phrase can be used to generate multiple private keys. Having access to the seed phrase effectively means having access to any of the private keys that the seed phrase can be used to generate. In general, for technical and security concerns, any particular private key should not exist in more than one location at a time, i.e., if a private key is stored on one device, it should not be stored on another device.

Recovery of access to the cryptocurrency or tokens, for example in situations where one of the private keys have been lost, typically involves the use of the seed phrase originally used to generate the private key. Specifically, when a cryptocurrency wallet is initially setup, the owner will be provided with the seed phrase that was used to generate the private keys and instructed to write down the seed phrase and store it in a secure location. If the owner of the digital wallet losses access to the digital wallet, and thus access to the owner's private keys, the owner has also lost access to the funds held by those keys in the smart contract on the blockchain. The owner can regain access to the private keys, and thus regain access to the underlying funds, by inputting the seed phrase into a replacement digital wallet, which will generate the private keys (and corresponding public keys) that were held in digital wallet. These newly regenerated private keys allow the owner to again access the cryptocurrency originally held by the digital wallet.

Due to the decentralized nature of blockchains, the seed phrase used to generate the private keys is typically only known by the digital wallet itself and the owner, who was informed of the seed phrase when the digital wallet was initially created.

It is well-known that many people are not very good at creating strong passwords or different passwords for different uses. Thus, many people typically use weak passwords that are easy to remember and use the same weak passwords for different uses. People are able to remember these passwords because they have chosen their passwords based on something familiar to them. In contrast, the seed phrase used to create the private keys for a digital wallet is not selected by the user, and thus will not necessarily be something that is easy for them to remember. Accordingly, although an owner of a digital wallet is provided with the seed phrase used to create the private keys for the digital wallet and informed that this seed phrase should be securely stored for future use, it is likely that many people will not remember the seed phrase, will not store the seed phrase in a secure location, or may not remember where the seed phrase was stored. This can be problematic to the wide-spread adoption of blockchain technology because as more people use digital wallets, there will be more instances of these people losing access to the digital wallets, and the cryptocurrency held by the digital wallets, and being unable to recover access to the digital wallet due to a failure to remember the seed phrase. Even with a relatively small number of people worldwide currently using blockchain technology, many of which are well aware of the importance of safely storing the seed phrase, there are many stories across the internet of people losing access to their keys and not remembering their seed phrase, and thus losing access to their cryptocurrency. Thus, so long as recovery methods for digital wallets rely solely upon the use of seed phrases for recovery of a digital wallet, it is likely that blockchain technology will face limited adoption by only the most technological savvy individuals.

In addition to the use of seed phrases, there have been some experiments with the use of social recovery. Social recovery involves the owner of the digital wallet providing different parts of the owner's private key to third parties. If the owner loses the private key, the owner can obtain the different parts from the third parties and combine them together to form the original private key. This requires the owner to identify a number of third parties that can be trusted because the third parties could collude behind the owner's back to combine the different parts of the private key to recreate the original private key. Social recovery does not provide any mechanisms for preventing these nefarious activities by third parties.

Another attempt to overcome the problems with seed phrases involves the use of a delay between the initiation of the recovery of a digital wallet and when the digital wallet is actually recovered. This technique allows anyone to initiate the recovery of the digital wallet and the delay allows the owner of the digital wallet to cancel the recovery in cases when the owner did not desire recovery (e.g., the process was initiated by a nefarious third party seeking to take control of the digital wallet). For this method to work in practice, the delay between the initiation of the recovery and the actual recovery must be long enough to allow for an actual owner to cancel a nefarious recovery attempt. Although many owners of digital wallets check their digital wallets on a daily basis, there are still owners that may not check their digital wallets for several months. Thus, to accommodate the behaviors of all types of owners of digital wallets, the delay would need to be set on the order of several weeks, if not on the order of months, to allow owners that do not regularly check their digital wallets to cancel nefarious attempts. However, during this delay period, the digital wallet is locked so that a legitimate recovery cannot be attempted, and thus the cryptocurrency held by the digital wallet cannot be accessed. Thus, many users would not accept a loss of access to the cryptocurrency for such a long period of time for the possibility of recovering access to the digital wallet.

Accordingly, there is a need for user-friendly systems and methods for recovering access to digital wallets.

### SUMMARY

Exemplary embodiments are directed to a method, which involves creating a digital smart contract wallet for an owner of the digital smart contract wallet. The creation of the digital wallet involves creating a multi-signature smart contract on a blockchain. The multi-signature smart contract requires one or more signatures to execute a transaction in the multi-signature smart contract. The multi-signature smart contract includes a recovery smart contract module that includes an address of a recovery owner public key and an address of a recovery controller public key. The recovery smart contract module requires only a single signature to execute a transaction in the multi-signature smart contract. Execution of transactions for the digital smart contract wallet requires signing a transaction with an owner private key. The method also involves recovering access by the owner to the digital smart contract wallet. This is achieved by creating a new owner public-private key pair and using a recovery transaction signed by a recovery owner private key and a recovery controller public key to update the digital smart contract wallet on the blockchain to require signing transactions with the new owner private key. The recovery owner private key is part of a key pair with the recovery owner public key, and the recovery controller private key is part of a key pair with the recovery controller public key.

Exemplary embodiments are also directed to a method for recovering access to a digital smart contract wallet having cryptocurrency stored on a blockchain with an address of an original owner public key. A recovery smart contract is created on the blockchain. The recovery smart contract includes an address of a recovery owner public key, a recovery controller public key, and a recovery block delay. A recovery request is initiated. A recovery owner private key is generated using a first secret from a first party and a user secret. A new owner public-private key pair is generated. At least one signed transaction to replace the original owner public key with the new owner public key is transmitted to the recovery smart contract. The signed transaction includes the original owner public key and new owner public key and is signed by the recovery owner private key and a recovery controller private key. The recovery smart contract replaces the original owner public key address with the new owner public key address responsive to confirmation that the recovery owner private key matches a corresponding recovery owner public key and the recovery controller private key matches a recovery controller public key.

Exemplary embodiments are also directed to a method for recovering access to a digital smart contract wallet stored on a blockchain. A new owner public-private key pair is created to replace a current owner public-private key pair for accessing the digital smart contract wallet. The digital smart contract wallet on the blockchain is updated to require a transaction signed by a new owner private key of the new owner public-private key pair for accessing the digital smart contract wallet. The digital smart contract wallet is updated using a recovery transaction signed by a recovery owner private key and a recovery controller private key to update the digital smart contract wallet on a blockchain to require signing transactions with the new owner private key. The recovery owner private key is part of a key pair with the recovery owner public key, and the recovery controller private key is part of a key pair with the recovery controller public key.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a flowchart of a method for recovering access to a digital smart contract wallet in accordance with exemplary embodiments;

FIGS. 2A and 2B are flow diagrams of a method for creating a digital smart contract wallet that can be recovered in accordance with exemplary embodiments; and

FIGS. 3A and 3B are flow diagrams of a method for recovering access to a digital smart contract wallet in accordance with exemplary embodiments.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of digital smart contract wallets and blockchain technology.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

Although embodiments of the invention can be used with any type of cryptocurrency or smart contract interactions, in the discussion below the cryptocurrency is tokens created for use in applications. Thus, the discussion below should be understood as providing one exemplary implementation that can be employed with other types of cryptocurrency. The discussion below uses the terms user and owner interchangeably to designate the party/entity that is the owner of the digital smart contract wallet, and thus references to a user should be understood as also referring to the owner, and vice-versa.

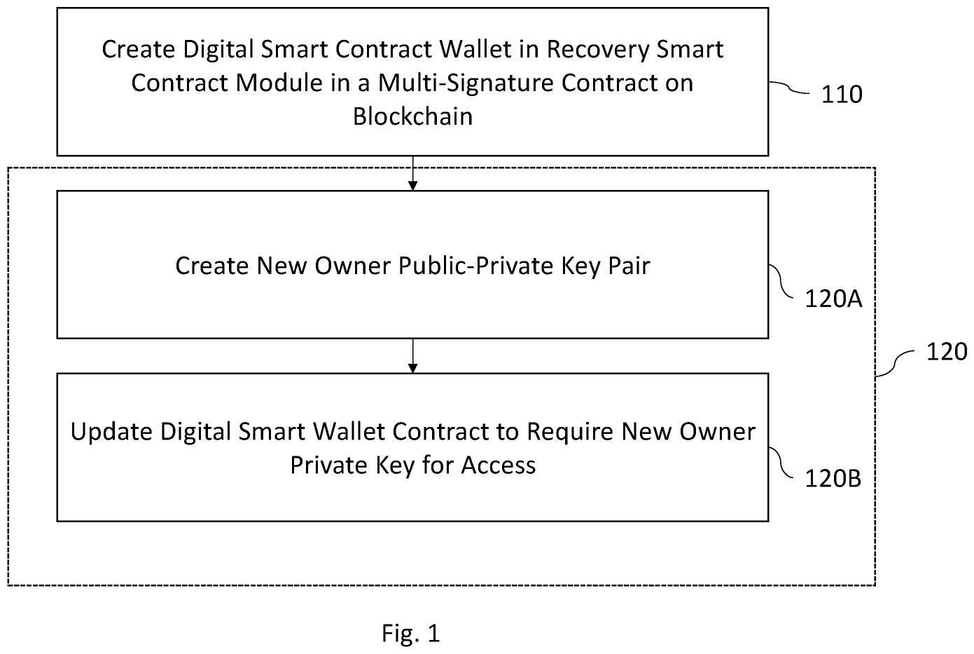

FIG. 1 is a flowchart of a method for recovering access to a digital smart contract wallet according to embodiments. Initially, the digital smart contract wallet for an owner of the digital smart contract wallet is created (step 110). This involves creating a multi-signature smart contract on a blockchain. The multi-signature smart contract requires one or more signatures to execute a transaction in the multi-signature smart contract. The multi-signature smart contract includes a recovery smart contract module that includes an address of a recovery owner public key and an address of a recovery controller public key. The recovery smart contract module requires only a single signature to execute a transaction in the multi-signature smart contract. Execution of transactions for the digital smart contract wallet requires signing a transaction with an owner private key. Next, access by the owner to the digital smart contract wallet is recovered (step 120). Specifically, a new owner public-private key pair is created (step 120A). A recovery transaction signed by a recovery owner private key and a recovery controller public key to update the digital smart contract wallet on the blockchain to require signing transactions with the new owner private key (step 120B). The recovery owner private key is part of a key pair with the recovery owner public key. The recovery controller private key is part of a key pair with the recovery controller public key.

Although the method for recovery illustrated in the flowchart of FIG. 1 involves both creation of the digital smart contract wallet and the recovery of access to the digital smart contract wallet, in one embodiment the method can involve only the recovery of access to the digital smart contract wallet, in which case only step 120 would be performed.

The underlying cryptoassets of the digital smart contract wallet can be stored in the multi-signature smart contract or in another smart contract. The method described above can involve either configuration. The methods described below assumes that tokens are being held by a token holder smart contract (also referred to as a TokenHolder smart contract). In this example, the TokenHolder smart contract is controlled, i.e., owned, by a multi-signature smart contract (also referred to as a MultiSig smart contract). It should be recognized that a TokenHolder smart contract is but one example and that the present invention can employ any other type of smart contract that is owned by a MultiSig smart contract, or similar smart contract. The TokenHolder smart contract is identified by the public address of the TokenHolder smart contract. For ease of explanation the cryptoassets are referred to as tokens. This should not be considered as limiting and instead any reference herein to tokens should also be understood as referring to any type of cryptoasset.

The MultiSig smart contract, which is the owner of the TokenHolder smart contract, is controlled, i.e., owned, by one or more private keys and is configured such that each of the owners of the MultiSig smart contract can act with a single signature. Thus, multiple owner keys can have authority over any particular TokenHolder contract or tokens held by the Multisig smart contract. This allows a user to have different owner keys on different devices, such as one on a mobile phone and one on a tablet, without sharing the same owner key across all of the user's devices.

The MultiSig smart contract requires a pre-agreed number of existing owners to sign a transaction to add, remove, or replace owner keys. This pre-agreed number of signatures is referred to as the threshold of the MultiSig smart contract. Thus, the threshold can be set to one signature or more than one signature, as desired. In order for the pre-agreed number of signatures to be changed, the pre-agreed number of owners must sign the transaction changing the pre-agreed number of signatures. The MultiSig smart contract can also store modules, which are independently executable code, which do not require the threshold number of signatures to enter a transaction in the module(s). One example of such smart contract meeting these conditions is a GnosisSafe smart contract. According to embodiments the MultiSig smart contract includes a DelayedRecoveryModule smart contract, which is configured to execute, after a configurable delay time period for added security, a swapOwner transaction, which replaces the original owner keys with new owner keys without meeting the threshold signature requirement for the MultiSig smart contract.

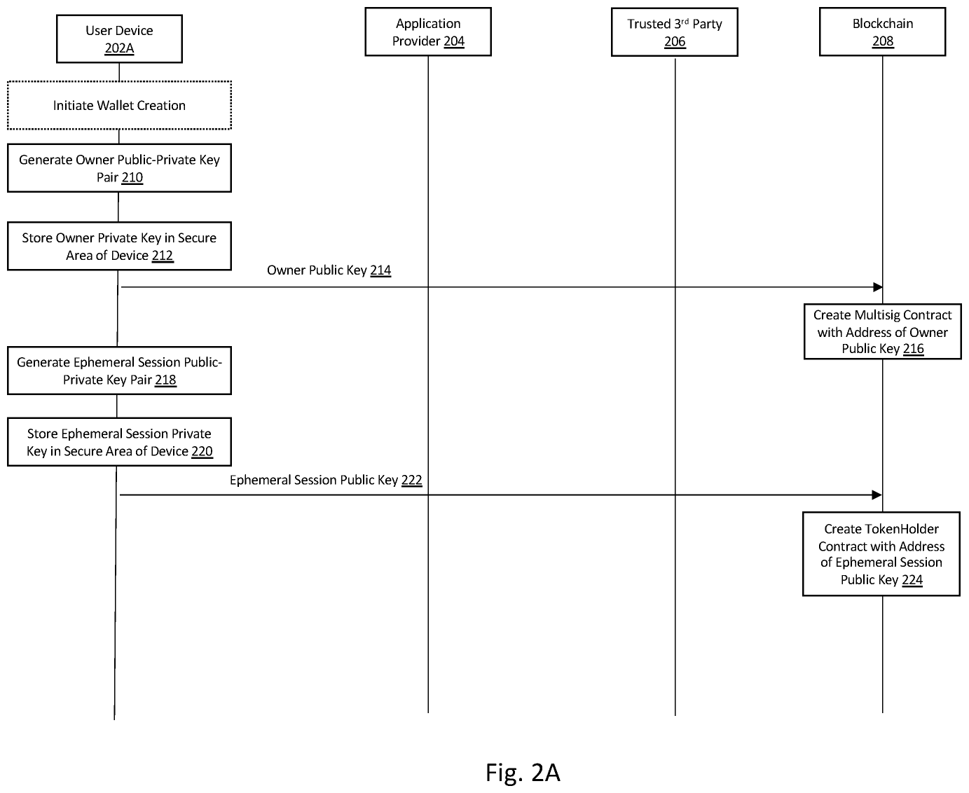

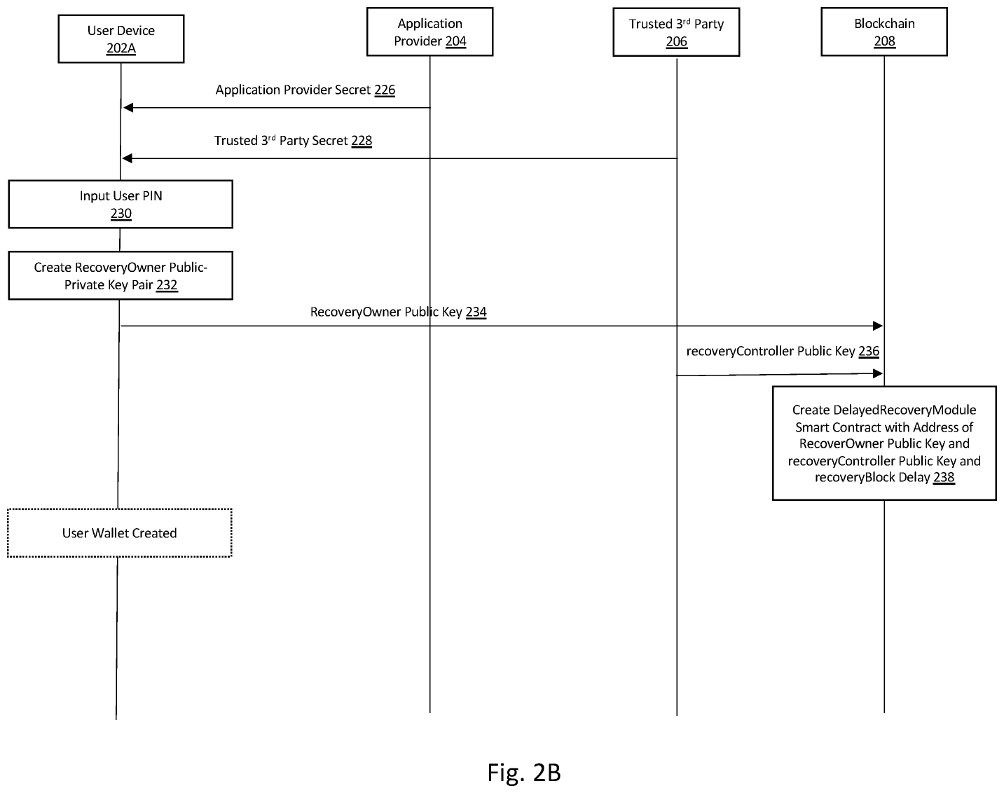

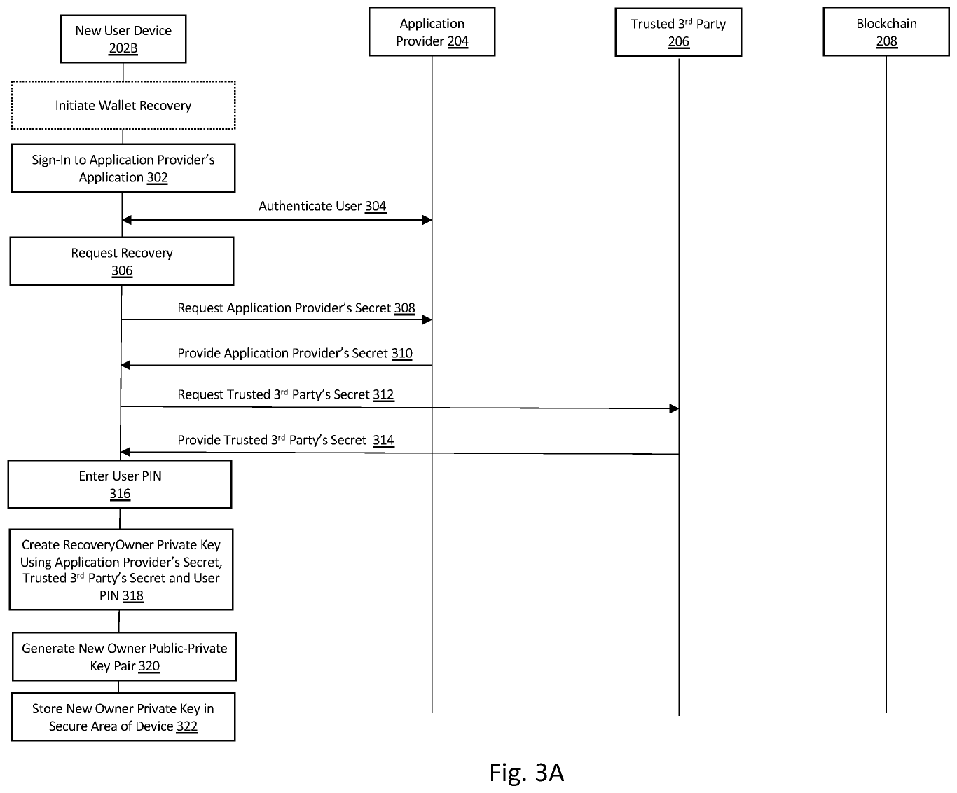

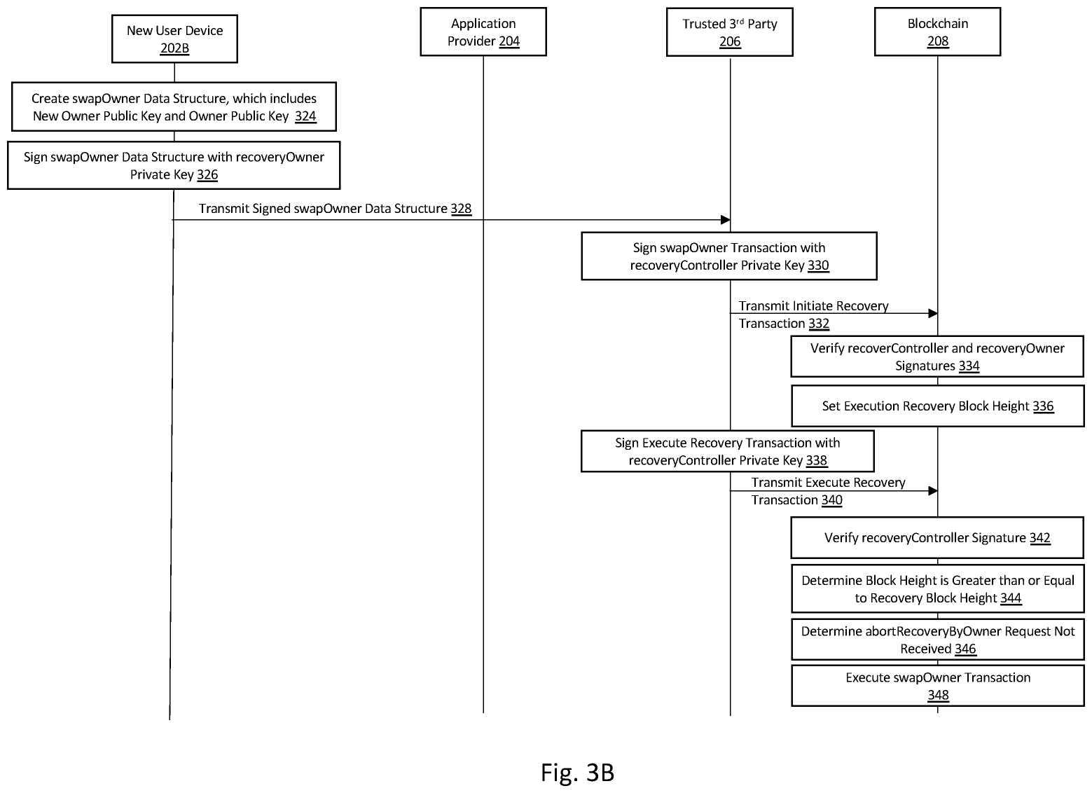

Now that an overview of some aspects of the invention have been provided, a more detailed explanation will be presented in connection with FIGS. 2A, 2B, 3A, and 3B. Because the DelayedRecoveryModule smart contract is deployed when the wallet is initially created, the discussion of the wallet creation will be described first in connection with FIGS. 2A and 2B, and then the methods for recovery will be described in connection with FIGS. 3A and 3B. These methods involve a user device 202A on which the digital smart contract wallet is created, an application provider 204 (which provides the tokens through an application employed by the user), a trusted third party 206 (which relays signed transactions on the user's behalf to the blockchain), and a blockchain 206 executing the MultiSig and TokenHolder smart contracts. The user device 202A (as well as the user device 202B discussed below) can be any type of device capable performing the functions disclosed herein, and can be, for example, a smartphone, tablet, computer, server, etc.

Turning first to FIG. 2A, the wallet creation process begins by the user device 202A generating the owner public-private key pair (step 210) and storing the owner private key in a secure area of the user device 202A (step 212). This secure area can be, for example, a secure enclave or any equivalent secure area of the device. The user device 202A then sends the owner public key to the blockchain 208 (step 214) and the blockchain 208 creates the MultiSig smart contract with an address corresponding to the owner public key (step 216).

After generating the owner key pair, the user device 202A generates the ephemeral session public-private key pair (step 218) and stores the ephemeral private key in a secure area of the user device 202A (step 220). The user device 202A then sends the ephemeral session public key to the blockchain (step 222). The blockchain 208 creates the TokenHolder smart contract with an address corresponding to the ephemeral session public key (step 224).

As discussed above, the recoveryOwner keys are generated based on inputs by the user, the application provider 204, and the trusted third party 206. Accordingly, the application provider 204 sends a secret to the user device 202A (step 226), the trusted third party 206 sends a secret to the user device 202A (step 228), and the user enters a password, such as a PIN (step 230). The user device 202A then creates the recoveryOwner public-private key pair (step 232). These secrets can be numerical, alphanumerical, and/or contain characters other than numbers and letters.

The user device 202A then sends the recoveryOwner public key to the blockchain 208 (step 234) and the trusted third party 206 sends a recoveryController public key to the blockchain 208 (step 236). The recoveryController public key is part of a public-private key pair created by the trusted third party 206, which key pair can be employed for all application providers or the trusted third party 206 can create a recoveryController public-private key pair for each application provider. The blockchain 208 then creates the DelayedRecoveryModule smart contract with the address of the recoveryOwner public key, the recoveryController public key, and the recoveryBlock Delay, which is a period defining the delay, in terms of blocks, between when a wallet recovery is initiated and when the wallet recovery is completed (step 238). In one example, the recoveryBlock Delay can be, for example, 14,400 blocks, which would be approximately 12 hours assuming that a block is added every three seconds. Thus, the user wallet creation process is completed.

Assuming now that the user has lost access to the user's wallet, and thus the owner private key, the wallet can be recovered using the method illustrated in FIGS. 3A and 3B. This process is initiated by the user's new device, which is designated by reference number 202B, signing-into the application providers application (step 302). In this case, the new user device 202B can be the same user device that was used to create the digital smart contract wallet or can be a different user device, for example in the case that the user is no longer in possession of the user device that created the digital smart contract wallet. The new user device 202B authenticates the user with the application provider 204 (step 304). This authentication employs the user credentials used for accessing the application provider's 204 application. The new user device 202B then indicates a desire to initiate recovery of the user's digital smart contract wallet (step 306). Although not illustrated, the application provider must register the new user device 202B with the trusted third party 206 so that authentication of the new user device 202B by the trusted third party 206 can succeed.

The new user device 202B, executing code in a wallet software development kit (SDK) provided by the trusted third party 206, then sends a request to the application provider 204 for the application provider's 204 secret that was used to create the recoveryOwner public-private key pair (step 308) and the application provider 204 sends the new user device 202B the application provider's 204 secret (step 310). The new user device 202B, executing code in the wallet SDK, also sends a request to the trusted third party 204 for the trusted third party's 206 secret that was used to create the recoveryOwner public-private key pair (step 312) and the trusted third party 314 provides that secret (step 314). The user then enters the user PIN that was used to create the recoveryOwner public-private key pair (step 316) and the new user device 202B, executing the wallet SDK, creates the recoveryOwner private key using the application provider's 204 secret, the trusted third party's 206 secret, and the user PIN 318 (step 318). This newly created recoveryOwner private key exactly matches the recoveryOwner private key that was generated when the wallet was initially created. The recoveryOwner private key can be created using any key-derivation algorithm, such as the scrypt cryptographic function.

Assuming that the wallet SDK determines that the created recoveryOwner address matches the recoveryOwner address generated when the digital smart contract wallet was initially created, the new user device 202B, executing code in the wallet SDK, generates a new owner public-private key pair using, for example, standard cryptographic libraries (step 320). If the two recoveryOwner addresses do not match, the wallet recovery process terminates. The new user device 202B, executing code in the wallet SDK, stores the newly generated owner private key in a secure area of the new user device 202B (step 322).

The new user device 202B, executing the code in the wallet SDK, then creates a swapOwner data structure, which includes the public address corresponding to the newly generated owner public key and the public address corresponding to the original owner public key that has been lost or stolen (step 324). Thus, the swapOwner data structure identifies the new public address corresponding to the newly generated owner public key that is to replace the previous public address corresponding to the original owner public key. The new user device 202B, executing code in the wallet SDK, signs the swapOwner transaction with the recoveryOwner private key that was generated when the digital smart contract wallet was initially created (step 326). The new user device 202B, executing code in the wallet SDK, sends the signed swapOwner data structure to the trusted third party 206 (step 328).

The trusted third party 206 signs the signed swapOwner data structure with the recoveryController private key (step 330) and transmits an initiate recovery transaction to the DelayedRecoveryModule smart contract on the blockchain 208, thereby initiating the swapOwner transaction on behalf of the recoveryOwner (step 332). The initiate recovery transaction includes the swapOwner data structure in its payload, and thus contains the new public address corresponding to the newly generated owner public key and the previous public address corresponding to the original owner public key.

The DelayedRecoveryModule smart contract on the blockchain 208 verifies the recoveryController and recoveryOwner signatures using the corresponding public keys (step 334) and sets the execution recovery height, which is the first block at which recovery can be executed, i.e., completed, which is determined by adding the recoveryBlockDelay to the block height when the wallet recovery is initiated (step 336). The trusted third party 206 signs an execute recovery transaction with recoveryController private key (step 338) and transmits the executed recovery transaction to the DelayedRecoveryModule on the blockchain 208 (step 340). The DelayedRecoveryModule smart contract on the blockchain 208 then verifies the recoveryController signature used to sign the execute recovery transaction is valid (step 344). Assuming that the recoveryController signature is valid, the DelayedRecoveryModule smart contract on the blockchain 208 determines whether the current block height is greater than or equal to the recovery block height (step 344) and whether an abortRecoveryByOwner request was received (step 346). For an abortRecoveryByOwner request to be valid, the request must be signed by the old 202A or new 202B user device with the recoveryOwner private key. Alternatively, or additionally, the recovery can also be aborted by the trusted third party 206 using an abortRecoveryByController request. For an abortRecoveryByController request to be valid the request must be signed by the trusted third party 106 with the recoveryController private key. If the current block height is greater than or equal to the recovery block height and the recovery process was not aborted due to receipt of an abortRecoveryByOwner and/or abortRecoveryByController request, then the DelayedRecoveryModule smart contract on the blockchain 208 executes the swapOwner transaction to replace the originally created owner public key with the newly created owner public key (step 348). Thus, the owner private key that was generated when the wallet was initially created will no longer be accepted for authorizing transactions using cryptocurrency held by the user's digital smart contract wallet and instead the newly created owner private key can authorize such transactions.

It should be recognized that the methods of the present invention have been described in FIGS. 2A, 2B, 3A, and 3B as occurring in a particular order for ease of explanation and should not be considered as limiting. For example, the generation of the owner public-private key pair and the ephemeral session public-private key pair can occur in the opposite order from what is illustrated in FIG. 2A or can be performed concurrently. Similarly, the order of providing the application provider and trusted third party secrets can be reversed or can be performed concurrently. Further, the order of the requesting of the application provider and trusted third party secrets in the wallet recovery can be reversed or these can be performed concurrently. Similarly, the user can enter the user PIN prior to or concurrently with the request and provision of the application provider and trusted third party secrets. The creation of the recoveryOwner private key and the new owner public-private key pair can be performed in the opposite order from what is illustrated or can be performed concurrently. Finally, the determination of the block height and whether an abortRecoveryByOwner request has been received can be performed continually after the initiate recovery transaction is received.

The disclosed methods and systems provide a more user-friendly technique for recovering access to a digital smart contract wallet. Specifically, the user only needs to remember a password, such as a PIN, that was selected by the user and can be as short as six digits. Six digits are considered the minimum required for security purposes, but the number of digits can be greater, for example, the PIN can be between six and ten digits. Because most people are accustomed to remembering telephone numbers that are at least ten digits, most people should have no problem remembering a set of digits that is less than ten digits, and accordingly the present invention can result in increased comfort with and adoption of blockchain technology and digital smart contract wallets. Although exemplary embodiments have been described in connection with a numerical PIN having a six digit length, the present invention can also be employed with a PIN having more than six digits and/or can include characters other than numbers or numbers and non-numeric characters. Further, the disclosed methods employ a trusted third party in a manner that does not allow the trusted third party to obtain a new owner private key without the owner's consent. In contrast, social recovery allows for the third parties holding the different portions of the owner's private key to recreate the owner's private key without the knowledge or consent of the owner.

Although exemplary embodiments have been described as employing a recovery block delay, this aspect can be replaced by or used in conjunction with other programmable security controls.

The disclosed embodiments provide systems and methods for recovering access to a digital smart contract wallet. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method, comprising:
creating a digital smart contract wallet for an owner of the digital smart contract wallet, which involves creating a multi-signature smart contract on a blockchain, wherein the multi-signature smart contract requires one or more signatures to execute a transaction in the multi-signature smart contract, the multi-signature smart contract includes a recovery smart contract module that includes an address of a recovery owner public key and an address of a recovery controller public key, the recovery smart contract module requires only a single signature to execute a transaction in the multi-signature smart contract, and wherein execution of transactions for the digital smart contract wallet requires signing a transaction with an owner private key; and
recovering access by the owner to the digital smart contract wallet by
creating a new owner public-private key pair, and
using a recovery transaction signed by a recovery owner private key and a recovery controller private key to update the digital smart contract wallet on the blockchain to require signing transactions with the new owner private key,
wherein the recovery owner private key is part of a key pair with the recovery owner public key, and the recovery controller private key is part of a key pair with the recovery controller public key.

2. The method of claim 1, wherein the recovery of access by the owner to the digital smart contract wallet further comprises delaying the update to the digital smart contract wallet on the blockchain to require signing transactions with the new owner private key for a predetermined amount of time.

3. The method of claim 2, wherein the predetermined amount of time corresponds to a block height of the blockchain.

4. The method of claim 2, wherein the recovery owner public-private key pair is generated using information from the owner and information from a third party.

5. The method of claim 4, wherein the information from the owner is an alphanumeric code.

6. The method of claim 4, wherein the information from the owner is a numeric code.

7. The method of claim 6, wherein the numeric code contains between six and ten digits.

8. The method of claim 4, wherein the digital smart contract wallet is associated with an application provided by an application provider, and wherein the recovery owner public-private key pair is generated using information from the owner, information from a third party, and information from the application provider.

9. The method of claim 8, wherein the recovery of access by the owner of the smart contract wallet further comprises the owner authenticating with the application.

10. The method of claim 1, further comprising:
storing a new owner private key of the new owner public-private key pair in a device associated with the owner.

11. A method for recovering access to a digital smart contract wallet having cryptocurrency stored on a blockchain with an address of an original owner public key, the method comprising:
creating a recovery smart contract on the blockchain, wherein the recovery smart contract includes an address of a recovery owner public key, a recovery controller public key, and a recovery block delay;
initiating a recovery request;
generating a recovery owner private key using a first secret from a first party and a user secret;
generating a new owner public-private key pair;
transmitting at least one signed transaction to replace the original owner public key with the new owner public key to the recovery smart contract, wherein the signed transaction includes the original owner public key and new owner public key and is signed by the recovery owner private key and a recovery controller private key; and
replacing, by the recovery smart contract, the original owner public key address with the new owner public key address responsive to confirmation that the recovery owner private key matches a corresponding recovery owner public key and the recovery owner private key matches a recovery owner public key.

12. The method of claim 11, wherein the replacement of the original owner public key address with the new owner public key address further requires that the blockchain has added a predetermined number of blocks since the initiation of the recovery request.

13. The method of claim 12, wherein the replacement of the original owner public key address with the new owner public key address further requires that programmable security parameters have been satisfied.

14. The method of claim 11, wherein the replacement of the original owner public key address with the new owner public key address further requires that programmable security parameters have been satisfied.

15. The method of claim 12, wherein if an abort recovery request is received by the recovery smart contract prior to the blockchain adding the predetermined number of blocks, the recovery is canceled, and the original owner public key address is not replaced by the new owner public key request.

16. The method of claim 11, wherein the recovery owner private key is generated using the first secret from the first party, the user secret, and a second secret from a second party.

17. A method for recovering access to a digital smart contract wallet stored on a blockchain, the method comprising:
creating a new owner public-private key pair to replace a current owner public-private key pair for accessing the digital smart contract wallet; and
updating the digital smart contract wallet on the blockchain to require a transaction signed by a new owner private key of the new owner public-private key pair for accessing the digital smart contract wallet, wherein the digital smart contract wallet is updated using a recovery transaction signed by a recovery owner private key and a recovery controller private key to update the digital smart contract wallet on a blockchain to require signing transactions with the new owner private key,
wherein the recovery owner private key is part of a key pair with the recovery owner public key, and the recovery controller private key is part of a key pair with the recovery controller public key.
